(19) United States
(12) Patent Application Publication
(10) Pub. No.: US 2006/0259976 A1
(43) Pub. Date: Nov. 16, 2006

(54) Method of and software for monitoring digital information

(76) Inventors: Michael Philip Thompson, Glen Iris (AU); Danny Jonathan Lesser, Ormond (AU); Saul Pascal Midler, Brighton East (AU); Lillian Pearce, Elstermwick (AU); Braham Daivd Rabino, Balachova (AU)

Correspondence Address: WILLIAMS MULLEN, 8270 GREENSBORO DRIVE, SUITE 700, MCLEAN, VA, 22102, US

(21) Appl. No.: 10/541,422

(22) PCT Filed: Jan. 7, 2004
(86) PCT No.: PCT/AU04/00012

§ 371 Date: Apr. 27, 2006

(30) Foreign Application Priority Data
Jan. 7, 2003 (AU) 2003900070

(51) Int. Cl. H04N 7/16

(52) U.S. Cl. 726/26

(57) ABSTRACT

A method of monitoring digital information including: creating a secure wrapper around the digital information using a method selected from a first wrapper method including directly embedding a first executable protection software portion in the digital information; or a second wrapper method including linking a second executable protection software portion to the digital information by way of an application program interface (API); or a third wrapper method including modifying the digital information and embedding a third executable protection software portion in the modified digital information; each of the first, second and third executable protection software portion including a specific performance portion operable by a user to perform one or more specific performance tasks, the or at least one of the specific performance tasks including a hardware environment check; selecting one of the first second or third wrapper methods according to the software and development platform of the digital information, the accessibility of the source code of the digital information, and/or the level of monitoring required; executing selected wrapper method by way of the first, second or third executable protection software portions including the steps of intercepting access to the digital information; checking that at least one of the specific performance tasks has been performed, including the hardware environment check has been performed; and validating whether or not the hardware environment corresponds to the hardware environment which has been previously checked.

### FIELD OF INVENTION

THIS INVENTION relates to a method of and software for monitoring digital information, having particular application to securing digital information against unauthorised access and/or use. Monitoring digital information in the context of the present invention is to be taken to include addressing security aspects as well as providing behavioural and/or market analysis functionality in respect of the usage of the digital information. The invention has particular application to use in respect of a plurality of computers linked to one another in a network, but it will be appreciated that the invention is not limited to this field of use.

### BACKGROUND ART

Digital information, generally in the form of program or data files stored on digital data storage device such as, for example, a hard disk drive, CD-ROM or such like, can represent a significant investment in time and money to develop. For the purposes of the present specification, unless the context indicates otherwise, the terms “digital information”, “data file”, “software” and the like are to be taken to include both executable program files and the like and non-executable data files and the like. The term “serial number” is to be taken to consist of potentially both numeric and non-numeric characters. The term “code-breaking methods” is to be taken to include such activities commonly known as “hacking” and the like.

Accessing digital information has been improved with the development of computer networks, particularly the Internet, with computers using modern applications such as web browsers and the like. However, there is a temptation for users to pilfer information or abuse the ready availability. Moreover, in some circumstances, privacy and/or security issues would make it undesirable to make digital information freely available, or at lease, available in an uncontrolled manner.

In the case of the Internet and the World Wide Web in particular, although some websites have restricted entry, once a user has accessed the information, that information is vulnerable to being taken and used in a way that could at best be undesirable, and at worst, illegal. Even in the case of webpages being generated from database or encrypted sources, once the information has been assembled and downloaded, it is vulnerable to abuse. Moreover, a strategy consisting solely of authenticating users leaves such unencrypted information vulnerable to unauthorised access by hackers or the like.

File transmission protocols may include an ability to restrict the functionality of the client computer receiving digital information in order to provide some form of protection. For example, in the case of web browsers, it is possible to embed extensions, applets or the like to prevent a client computer from, for example, printing a file, saving it to disk, or partly disabling a mouse or a keyboard. However, these measures can often be circumvented if the user of the client computer is sufficiently experienced.

The Internet has also become a common route by which software is purchased. Even when software is purchased through normal retail channels, once it has ben purchased, the software is often required to be registered with the software producer or retailer as part of the installation process in order to decrease the likelihood of unauthorised copying of the software. However, such protection systems may sometimes be circumvented, or may be difficult to implement.

Present methods of monitoring digital information do not provide substantial ability to perform behavioural or market analysis in respect of usage of that digital information. Neglected aspects include, for example, tracking piracy attempts, geographic distribution and usage, network location, sex, age and occupation, contact details and methods, tracking production, sale, distribution chain and user registration steps, user feedback, post-registration usage, PC-platform age, PC-hardware usage and marketing profile.

There are some systems which rely on hardware profiles for registration, security checks, product activation or such like. For example, one proposed for product activation has been proposed by Microsoft in the Windows XP operating system for microcomputers. However, such systems have limitations. There are some systems which incorporate what may be described as “terminal services software” which in operation set up multiple sessions with clients and sometimes create a virtual image of every client on the server in a similar fashion to older multiple virtual storage systems having a plurality of dumb terminals connected to a mainframe computer. Because only a limited amount of information is transmitted between the clients and the server, and all users are running applications on the same hardware, hardware signature based security systems have difficulty protecting applications on such systems.

Software product activation systems sometimes cause problems for users if the software is to be moved from one machine to another. Re-registration is often required, but usually only if an uninstall code has been generated by uninstalling the software product from the original machine. Most activation systems cannot accommodate circumstances where hardware failure requires reinstallation and reactivation of software from original media onto a different machine from that where it was originally installed.

The present invention aims to provide method of and software for monitoring digital information which alleviates one or more of one of the aforementioned disadvantages. The invention also aims to provide digital information protected by the method and/or software of the invention Other aims and advantages of the invention may become apparent from the following description.

### DISCLOSURE OF THE INVENTION

With the foregoing in view, this invention in a first aspect resides broadly in a method of monitoring digital information including:

creating a secure wrapper around the digital information using a method selected from:
a first wrapper method including directly embedding a first executable protection software portion in the digital information; or
a second wrapper method including lining a second executable protection software portion to the digital information by way of an application program interface (API); or
a third wrapper method including modifying the digital information and embedding a third executable protection software portion in the modified digital information;

each of the first, second and third executable protection software portion including a specific performance portion operable by a user to perform one or more specific performance tasks, the or at least one of the specific performance tasks including a hardware environment check;

selecting one of the first second or third wrapper methods according to the software and development platform of the digital information, the accessibility of the source code of the digital information, and/or the level of monitoring required;

executing selected wrapper method by way of the first, second or third executable protection software portions including the steps of:

intercepting access to the digital information;

checking that at least one of the specific performance tasks has been performed, including the hardware environment check has been performed; and

validating whether or not the hardware environment corresponds to the hardware environment which has been previously checked.

Once the monitoring has been or is being performed in accordance with the invention, access to the digital information may be provided in a manner transparent to the user that the digital information has been or is being monitored.

In a second aspect, the present invention resides broadly in a method of monitoring digital information including:

creating a secure wrapper around the digital information by embedding an executable protection software portion in the digital information, the executable protection software including a specific performance portion operable by a user to perform one or more specific performance tasks, the or at least one of the specific performance tasks including a hardware environment check;

the secure wrapper being operable to:
intercept access to the digital information;
check that at least one of the specific performance tasks, including the hardware environment check has been performed; and
validate whether or not the hardware environment corresponds to the hardware environment which has been previously checked.

In a third aspect, the present invention resides broadly in a method of monitoring digital information including:

creating a secure wrapper around the digital information by including linking an executable protection software portion to the digital information by way of an application program interface (API), said executable protection software portion including a specific performance portion operable by a user to perform one or more specific performance tasks, the or at least one of the specific performance tasks including a hardware environment check;

the secure wrapper being operable to:
intercept access to the digital information;
check that at least one of the specific performance tasks, including the hardware environment check has been performed; and
validate whether or not the hardware environment corresponds to the hardware environment which has been previously checked.

In a fourth aspect the present invention resides broadly in a method of monitoring digital information including:

creating a secure wrapper around the digital information by modifying the digital information and embedding an executable protection software portion in the modified digital information;

the executable protection software including a specific performance portion operable by a user to perform one or more specific performance tasks, the or at least one of the specific performance tasks including a hardware environment check;

the secure wrapper being operable to:
intercept access to the digital information;
check that at least one of the specific performance tasks has been performed, including the hardware environment check has been performed; and
validate whether or not the hardware environment corresponds to the hardware environment which has been previously checked.

Once the monitoring has been or is being performed in accordance with the invention, access to the digital information may be provided in a manner transparent to the user that the digital information has been or is being monitored.

Preferably, the specific performance includes an exchange of codes between a client computer and a server computer operatively connected to the server computer. Preferably, the exchange of codes includes:

the uploading of a code corresponding to the hardware environment of the client computer;

the uploading of a code corresponding to the digital information, such as, for example, a unique serial number or the like issued for that particular example of digital information; and

the downloading of a code corresponding to a key for entry into the client computer for accessing the digital information on an ongoing basis or for a selected countable unit.

In a preferred form, the countable unit is time, and periods of time may be divided or quantized to provide a selected period of time. However, other countable units may be used, such as traffic counters, site access counts or such like.

In the case of the digital information being in the form of non-executable data, such as, for example, a webpage, database, text file, spreadsheet, or the like, it is preferred that the third wrapper method be selected.

Preferably, one of the specific performance tasks includes checking whether an operating system is operating having multiple virtual storage. If such a system is detected, the method substitutes a system user account check instead of the hardware environment check, and performs the remainder of the method using the user account information instead of the hardware information.

In a fifth aspect, the present invention resides broadly in a method of monitoring digital information in the form of a non-executable, browser-readable code and/or content including:

creating a mapping table capable of translating and preserving text, all object paths, extensions and such lice within a single container or file structure to form a mapped file;

converting the mapped file into an executable file structure to form a conversion file;

encrypting the conversion file to form an encrypted file embedding protection software as herein described to enable dynamic decryption of selected content of the encrypted file when correctly registered.

For example, where the non-executable file is in the form of a file in hypertext markup language (HTML), possibly including applets, MIME for non-text content, or other non-text inclusions, the data file is converted into an executable file which provides the exchange of codes described herein. In such form, it is further preferred that the exchange of codes includes the downloading of an encryption key, and the executable file includes information encrypted according to the key. The method in this case includes the encoding of the digital information using the key generated for the particular client computer, such that the same digital information may be provided in a different form, being encoded with a different encryption key, for each client computer connected to the server.

In a sixth aspect, the present invention resides broadly in a system architecture for providing monitoring of digital information, including:

primary web server means for serving a computer network;

a plurality of client computers operatively connected to the primary web server means by way of the network;

one or more registration server means operatively connected to the primary web server and operatively connectible to the client computers by way of the network;

registration support means operatively associated with the primary web and registration server means for supporting the functionality of the primary web and registration server means;

wherein the primary web server means is operable to provide validation of a call from any client computer, tracking the client computer and if required redirecting the call;

and wherein the registration server means is operable to provide registration of each client computer when operatively connected thereto by way of the network;

the operative association of the registration support means including alternative means of communicating information between the client computers and the registration server means for client computers which are not connected thereto and the registration support means being operable to provide or functional in providing for registration of any client computer by way of the alternative means of communicating.

Optionally, if the primary web server is, or becomes, inoperable, the method may include validating a call from any client computer and tracking the client computer. The alternative means of communicating could include, for example, provision for web form, email, telephone, fax or postal transmission of relevant information instead of direct online communication.

Preferably, the architecture further includes data analysis means operatively connected to the registration server means for analysing the registration, usage or other billing, behavioural, demographic and/or market analysis of information received from the client computers in the registration and usage of digital information.

In a seventh aspect, the present invention resides broadly in a method of protecting software, the method insofar as the installation and registration of the software including the steps of:

installing the software on a computer;

after installing the software, running the software for a first time; upon the running of the software on the computer, generating an installation code from the hardware profile of the computer;

after generating the installation code, requesting a unique serial number from an authorisation source, the request including providing the hardware profile of the computer;

after requesting the serial number, registering the software with a registration authority using the serial number and installation code;

receiving a positive or negative reply from the registration authority;

upon the receipt of a negative reply from the registration authority, returning to the step of requesting a serial number and following the steps thereafter;

upon the receipt of a positive reply from the registration authority, receiving a registration key from the registration authority and saving the registration key on the computer, whereupon the software may be executed insofar as its functional performance is concerned;

the method insofar as the post-registration running of the software including the further steps of:

running the software on the computer;

upon the running of the software on the computer, generating an installation code from the hardware profile of the computer;

after the hardware profile has been generated, comparing the registration key with the hardware profile;

upon the matching of the hardware profile with the registration key, permitting the software to executed insofar as its functional performance is concerned;

upon the failure of the hardware profile to match the registration key, denying permission for the software to executed insofar as its functional performance is concerned.

Preferably, the computer is a client computer operably connectible to a server computer, and the serial number and registration key are uploaded and downloaded (as the case may be) between the client and server computers when operably connected to one another.

In an eighth aspect, the present invention resides broadly in a method of monitoring digital information including:

adding a protection software portion;

modifying the protection software portion so as to mask its identifying characteristics and behaviour. For example, operative portions of program code may be embedded into other code which is, apparently, functional, but never called by the actual program in its operation.

In a ninth aspect, the present invention resides broadly in a method of monitoring digital information having a protection software portion as hereinbefore described, including;

adding a specific performance portion for checking for the presence of code-breaking methods;

checking for the presence of code-breaking methods to provide a check result; and

modifying the behaviour of the protection software portion in accordance with the check result.

Where software which has been registered with a registration server is to be transferred from one machine (the original machine) to another (the new machine), the method, system and software of the present invention provides functionality to:

check to determine whether the software is registered;

accommodate uninstallation of the software from the original machine;

communicate with the registration server to re-activate the registration of the software on the new machine;

if the registration server cannot be contacted, a transfer key is generated which provides evidence that the application has been successfully uninstalled, the transfer key being required to be provided as part of a new installation to activate the software.

The transfer key may be either manual, involving a support call, or electronic. Sophisticated attempts to create a copy of the hard drive contents before uninstalling are protected against by limiting the number of transfers that are permitted in a particular period of time.

Where software is to be tracked without necessarily invoking the security aspects, user information is requested to be entered into a form, but if the information is not entered, the software is permitted to start, but will prompt the user every time it is run to provide information. If requested information is entered, the software will not ask for user information every time it is run unless set to do so according to some measurable quantity, such as time, number of starts, quantity of data processed or such lice. The number of copies of software installed without tracking to and from a point of origin may be tracked, monitoring each and every instance that the software is installed, obviating the requirement for a serial number to be entered. Alternatively, number of copies of software installed, but in this example, with tracking to and from a point of origin may be tracked, still monitoring each and every instance that the software is installed, but in this case, requiring a serial number to be entered. It can be seen that in each case, information can be requested to provide feedback and/or marketing information.

### BRIEF DESCRIPTION OF THE DRAWINGS

In order that the invention may be more readily understood and put into practical effect, reference will now be made to the accompanying drawings which illustrate a preferred embodiment of the invention and wherein:—

FIG. 1 is a flowchart illustrating a method of monitoring digital information according to the invention;

FIG. 2 is a flowchart illustrating a method of converting browser readable digital information according to the invention; and

FIG. 3 is a diagrammatic representation of an architecture for monitoring digital information according to the invention.

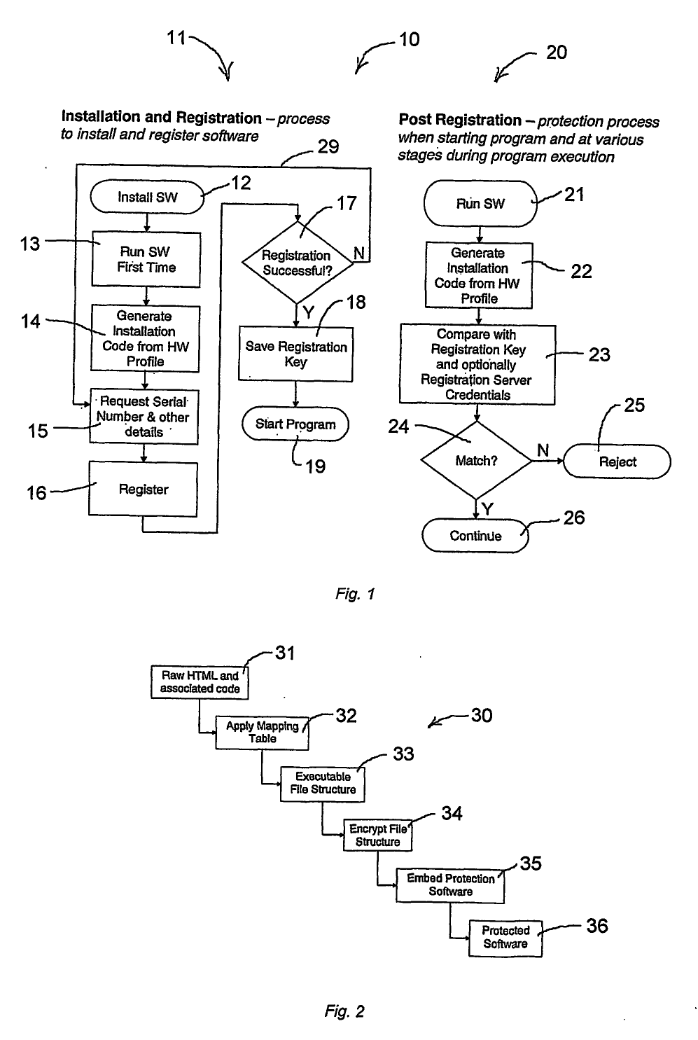

### DETAILED DESCRIPTION OF THE DRAWINGS

The method 10 illustrated has in two stages, an installation and registration stage 11 and a post registration stage 20. In the first stage, a user installs software at step 12 and runs the software at step 13 using the normal commands of the computer upon which the method of the present invention is to be performed. At step 14, the running of the software generates an installation code from the hardware profile of the computer. The software then requests a serial number and other details, such as name, address, contact details and the lice at step 15. The registration process is then instituted in accordance with the procedures hereinbefore described at step 16, usually byway of an Internet connection to a web server computer. If the registration is successful at step 17, a registration key is saved at step 18, otherwise, if specific security parameters have been exceeded at step 20, the software exits at step 21 or returns the user to step 15. Upon the saving of the registration key in step 18, the application program installed by the foregoing steps is executed at step 19.

In the second stage at 22, for each subsequent running of the program at step 19 described, a sequence of prerequisite steps are performed in accordance with the invention, these being described hereinafter. The software is run at step 23, whereupon an installation code is generated from the hardware profile of the computer at step 24 in a similar fashion to that of step 14 above. The saved registration key at step 18 is compared to that required of a computer having the matching installation code at step 25. At step 26, a negative match rejects further execution of the program at step 27, but a positive permits the program to continue at step 28 in a similar fashion to that of step 19 described above.

The method 30 for protection of webpages described in FIG. 2, includes the following steps. The raw HTML and associated browser-readable code and/or content is received at step 31. A mapping table is applied to the code at step 32. The mapped data is converted into an executable file at step 33, which is then encrypted at step 34. The software protection described herein is embedded into the encrypted file at step 35 to produce protected software at step 36.

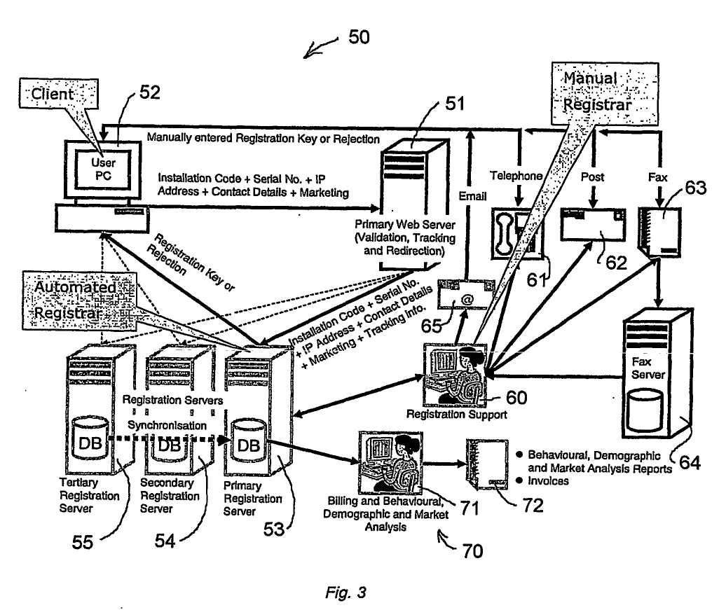

The system architecture 50 illustrated in FIG. 3 includes a primary web server 51 operatively connected to a primary registration server 53, a secondary registration server 54 and a tertiary registration server 55. A client computer 52 (of which there would normally be a plurality, one only being shown for clarity) is operatively connected to the web server and the registration servers. Communication may be routed automatically through a primary web server 51 or manually via a web form 56. The architecture provides for removal of the primary web server, in which case, the client computer 52 os operatively connected to the registration server 53, 54 or 55. Registration support shown at 60 is operatively associated with the registration server, normally by telephone at 61 but the architecture also provides alternative communication methods, including email 65, postal service 62 and fax transmission 63. The fax communication may be routed through a fax server 64 or received in hardcopy by registration support. The architecture also provides for monitoring other than security such as data gathering at 70, which includes billing and behavioural, demographic and market analysis functions at 71 for production of reports and/or invoices at 72.

In order that the invention may be more readily understood and put into practical effect, reference will now be made to an example of the invention in use. The first time an application program is started on a client computer, the protection software will generate an installation code which is based on a number of parameters unique to the computer platform on which the application is installed.

A unique serial number, entered by the client, and the installation code are supplied to the registrar. A mathematically-related unlock or registration key, which can only be generated by the registrar with the specific key-generation program for that application, is returned to the client. The registrar may be an Internet-connected server of a software tool administered by a support person. If the Internet registration server option is chosen, entry of the registration key is automatic and transparent to the user once the user has entered the required information.

Until the registration key has been successfully entered, each time the application is started, it will request the key. Once the key has been entered, it will be compared with the parameters described above. If the software is copied to another computer, it will again follow the registration process as the new system parameters, typically unique to each computer, will not match.

In relation to HTML and related content, the method of the present invention addresses a special challenge for the protection as the content itself is not an executable program in its own right and can in the absence of the protection afforded by the method of the present invention be read, modified and displayed by numerous editors and browsers. The method of the present invention converts HTML code, including java script, XML and any other type of browser-readable code and/or content to an encrypted, protected, executable file structure while preserving all normal browser functionality and compatibility. Content can be protected on CD-ROM or any other media, including remotely referenced content on a web server. In the case of a web server, converted and encrypted files are held on the web server. The files are viewed via the protected local client software which decrypts the files prior to viewing.

Utilising web-based content enables authors to update content on the server without any modification to client code while still maintaining protection.

For example, the user starts the program for the first time and is requested to enter their contact details, unique serial number supplied with the purchased software and optional marketing and demographic information. The protection software of the present invention generates a unique installation code based on selected parameters unique to the computer platform on which the application is installed. If Internet connection is present, the above information is uploaded to the registration server. If an Internet connection is not present, the user is guided through the options of registration by post, fax or telephone to the manual registrar (at 60 in FIG. 3). The client receives the required Registration Key or if the registration criteria are not valid a rejection is issued and the software will not function.

In the case of automated registration by way of the Internet or the like, including client direct or via a web form, the primary web server validates the client information, adds IP address tracking information and forwards the request to the first available registration server. If the primary web server option is not used, the first available registration server validates the client information, adds IP address tracking information and processes the request. The registration and tracking information is captured in the database and compared with the registration history. If the specific registration criteria are met, a valid registration key is sent to the client. If not, the request is rejected. All registration details in the database are automatically synchronised with each registration server.

In the case of manual registration, the registration details are received by a nominated representative via telephone, fax or post. Registration information is captured with software specifically designed for the registrar. The registrar software is itself protected by the software protection method of the present invention and can be dynamically controlled in terms of its ability to be registered itself and to register software users.

The registrar software captures registration information in the database and compares it with the registration history via a secure Internet link to the registration server. If the specific registration criteria are met, a valid registration key is returned to the client via their nominated method of receiving the registration details (email, telephone, fax, post, etc). If the specific registration criteria are not met, the request is rejected and a corresponding message is returned to the client via their nominated method of receiving the registration details. If successful, the user manually enters the supplied registration details into the protection software screen provided.

In performing the method of the invention, several options may be selected for software registration. As a first example, only a specific number of registrations per serial number may be permitted by the software vendor. As a second example, registrations within an allowable range of serial numbers may be pre-allocated by the software vendor. As a third example, registration for a trial or demonstration period registration may be time limited. As a fourth example, the number of times that registrations may be limited. As a fifth example, the PC-platform parameters used to uniquely identify the installation can be varied to suit the strength or uniqueness required by the software vendor. As a sixth example, the number of registrations allowable on the same PC platform may be limited as identified in the fifth example. As a seventh example, concurrent licensing may be provided for. A specific number of licences can be shared across any Internet-connected PC's. The software may be installed on any PC but will not run without first validating with the registration server that a licence is available for use. As an eighth option, licence transferral may be provided by permitting a serial number to be released for re-use by the user after validation of licence cancellation on that platform.

In performing the method of the invention, several options may be selected for behavioural and market analysis. As a first example, providing behavioural and/or market analysis in respect of the nature and number of piracy attempts by comparing all successful and unsuccessful registration attempts for specific PC platforms, clients, networks and software distributions. As a second example, providing real-time behavioural and/or market analysis in respect of the geographic and network distribution and usage of software. As a third example, providing real-time behavioural and/or market analysis in respect of the sex, age and occupation of clients. As a fourth example, providing targeted marketing to specific clients and client groups utilising contact details, preferred contact methods and other monitoring information. As a fifth example, providing real-time behavioural and/or market analysis in respect of sales, distribution chain and user registration steps including timing and volumes. As a sixth example, providing real-time behavioural and/or market analysis in respect of post-registration usage including frequency, duration and functionality. As a seventh example, providing real-time behavioural and/or market analysis in respect of the PC platform type and age used. As an eighth example, providing real-time behavioural and/or market analysis in respect of product specific user feedback.

The method, system and software of the present invention may be used to provide software tracking functionality without necessarily invoking the security functionality. Such an application permits recording of retails of each installation of software for tracking purposes. Software will be permitted to run, but will prompt the user to register each time the software is started, until the user has registered the software. Preferably, registration is via a network, such as the Internet. Such a tracking arrangement allows the collection and analysis of end-user data. Depending on the configuration, data for tracking and analysis of specific distributions to and from a point of origin may be collected. Behaviours, such as, for example, piracy attempts, sharing, demographic, product feed back and marketing information may be collected.

Although the invention has been described with reference to specific examples, it will be appreciated by persons skilled in the art that the invention may be embodied in other forms without departing from the broad scope and ambit of the invention as claimed by the following claims.

1. A method of monitoring digital information including: creating a secure wrapper around the digital information using a method selected from:
a first wrapper method including directly embedding a first executable protection software portion in the digital information; or
a second wrapper method including linking a second executable protection software portion to the digital information by way of an application program interface (API); or
a third wrapper method including modifying the digital information and embedding a third executable protection software portion in the modified digital information;
each of the first, second and third executable protection software portion including a specific performance portion operable by a user to perform one or more specific performance tasks, the one or more specific performance tasks including a hardware environment check;
selecting one of the first second or third wrapper methods according to a software and development platform associated with said digital information, the accessibility of the source code of the digital information, or the level of monitoring required;
executing the selected wrapper method by way of the first, second or third executable protection software portions including the steps of;
intercepting access to the digital information;
checking that at least one of the one or more specific performance tasks has been performed, including that said hardware environment check has been performed; and
validating whether or not the hardware environment corresponds to the hardware environment which has been previously checked.

2. A method according to claim 1, wherein one of said one or more specific performance tasks includes checking whether an operating system is operating having multiple virtual storage and a system user account check is performed, whereupon the remainder of the method uses the user account information instead of or in addition to the hardware environment check.

3. A method according to claim 1 wherein said digital information is in the form of a non-executable, browser-readable code or content and wherein said method includes the steps of:
creating a mapping table capable of translating and preserving text, object paths, and extensions within a single container or file structure to form a mapped file;
converting the mapped file into an executable file structure to form a conversion file; and
encrypting the conversion file to form an encrypted file to enable dynamic decryption of selected content of the encrypted file when correctly registered.

4. A system architecture for providing monitoring of digital information, including:
primary web server means for serving a computer network;
a plurality of client computers operatively connected to the primary web server means by way of the network;
one or more registration server means operatively connected to the primary web server and operatively connectible to the client computers by way of the network;
registration support means operatively associated with the primary web and registration server means for supporting the functionality of the primary web and registration server means;
wherein the primary web server means is operable to provide validation of a call from any client computer, tracking the client computer and if required redirecting the call;
and wherein the registration server means is operable to provide registration of each client computer when operatively connected thereto by way of the network;
the operative association of the registration support means including alternative means of communicating information between the client computers and the registration server means for client computers which are not connected thereto and the registration support means being operable to provide or functional in providing for registration of any client computer by way of the alternative means of communicating.

5. A system architecture according to claim 4, further including data analysis means operatively connected to the registration server means for analysing the registration, usage or other billing, behavioural, demographic or market analysis of information received from the client computers in the registration and usage of digital information.

6. A method of protecting software, the method insofar as the installation and registration of the software including the steps of:
installing the software on a computer having a hardware profile;
after installing the software, running the software for a first time;
upon the running of the software on the computer, generating an installation code from said hardware profile of the computer;
after generating the installation code, requesting a unique serial number from an authorisation source, the request including providing said hardware profile of the computer;
after requesting the serial number, registering the software with a registration authority using an obtained serial number and said installation code;
receiving a positive or negative reply from the registration authority;
upon the receipt of a negative reply from the registration authority, returning to the step of requesting a serial number and following the steps thereafter;
upon the receipt of a positive reply from the registration authority, receiving a registration key from the registration authority and saving the registration key on the computer, whereupon the software may be executed insofar as its functional performance is concerned;
the method insofar as the post-registration running of the software including the further steps of:
running the software on the computer;
upon the running of the software on the computer, generating an installation code from the hardware profile of the computer;
after the hardware profile has been generated, comparing the registration key with the hardware profile;
upon the matching of the hardware profile with the registration key, permitting the software to executed insofar as its functional performance is concerned;
upon the failure of the hardware profile to match the registration key, denying permission for the software to executed insofar as its functional performance is concerned.

7. A method of monitoring digital information including:
providing a protection software portion;
modifying the protection software portion so as to mask its identifying characteristics and behaviour.

8. A method of monitoring digital information having a protection software portion, including;
adding a specific performance portion for checking for the presence of code-breaking methods;
checking for the presence of code-breaking methods to provide a check result; and
modifying the behaviour of the protection software portion in accordance with the check result.
